(19) United States
(12) Patent Application Publication
(10) Pub. No.: US 2009/0261021 A1
(43) Pub. Date: Oct. 22, 2009

(54) Oil sands processing

(76) Inventor: David J. Bower, Nottinghamshire (GB)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 12/148,128

(22) Filed: Apr. 16, 2008

(51) Int. Cl. C10G 1/04; B01J 19/00

(52) U.S. Cl. 208/390; 422/255

(57) ABSTRACT

Some embodiments relate to an oil sands processing system comprising a release tube, a water supply nozzle and an intake nozzle forming an inlet of the tube, with the nozzles configured to pass water from the supply nozzle to the intake nozzle across a gap positioned to receive oil sand and air to form a slurry for passage along a flow path, with the intake nozzle diameter being larger than the supply nozzle diameter and the tube further comprising a constriction comprising a diameter that is less than the intake nozzle diameter and greater than the supply nozzle diameter.

### TECHNICAL FIELD

The technical field relates to mineral oils processes and products, specifically tar sand treatment to produce oil.

### BACKGROUND

Bituminous sands, also referred to as oil sands, are a mixture of sand or clay, water, and heavy crude oil. Many countries in the world have large deposits of oil sands, including the United States, Russia, and various countries in the Middle East. Three quarters of the world's reserves, however, are found in Venezuela and Canada. Oil sands may represent as much as two-thirds of the world's total petroleum resource but are difficult to develop because it is so expensive to recover oil from these sands. The term oil sands does not include oil-bearing rocks with relatively lighter oils that are recovered by oil-well drilling processes.

The Canadian oil sands have been in commercial production since the original Great Canadian Oil Sands mine began operation in about 1967. A second mine, operated by the Syncrude consortium, began operation in about 1978 and at this time is the biggest mine of any type in the world. The third mine in the Athabasca Oil Sands began operation in about 2003.

Oil sand deposits are strip mined or otherwise made to flow into wells by in situ techniques that typically involve steam and/or solvents. Various extraction techniques are used, or have been tried. In the cold flow technique, the oil is pumped out of the sands, often using specialized pumps called progressive cavity pumps. The oil, however, must be fluid enough to pump so that this method only works in particular formations. The cyclic steam stimulation method uses a well that is put through cycles of steam injection, soak, and oil production. Steam assisted gravity drainage involved two horizontal wells drilled in the oil sands, one at the bottom of the formation and another several yards above it; steam is forced down one well and helps oil to flow out of the other well. The vapor extraction process is similar, but hydrocarbon solvents are injected into the upper well to dilute the bitumen and allow it to flow into the lower well. All of these processes require large amounts of energy.

Surface mining has been used for about 40 years in the Athabasca Oil Sands. Originally, the sands were mined with draglines and bucket-wheel excavators and moved to the processing plants by conveyor belts. However, in recent years companies such as Syncrude and Suncor have switched to shovel-and-truck operations using the biggest power shovels (100 or more tons) and dump trucks (400 tons) in the world. After excavation, hot water and caustic soda (NaOH) are typically added to the sand, and the resulting slurry is piped to the extraction plant where it is agitated and the oil skimmed from the top. Provided that the water chemistry is appropriate to allow bitumen to separate from sand and clay, the combination of hot water and agitation releases bitumen from the tar sand, and allows small air bubbles to attach to the bitumen droplets, a process referred to as aeration. The aerated bitumen froth floats to the top of separation vessels, and is further treated to remove residual water and fine solids. Bitumen is much thicker than traditional crude oil, so it must be either mixed with lighter petroleum (either liquid or gas) or chemically split before it can be transported by pipeline for upgrading into synthetic crude oil.

Utah's Tar Sand Resource has a combined shallow oil resource of about 30 billion barrels of oil. These have been quarried since the early 1900s primarily for road paving material. Efforts to develop Utah's heavy oil, however, have met with poor success due to inefficient processing technologies. Utah oil sand is an asphaltic bitumen that is difficult to process using techniques pioneered in fields such as the Athabasca Oil Sands.

### SUMMARY OF THE INVENTION

Revolutionary technology that uses cold water to release oil from oil sands is described herein. This result is revolutionary since enormous amounts of energy can be saved if the oil sands do not have to be heated for the release process. The technology also minimizes infrastructure to process the oil sands to thereby make production possible at many sites that do not have reserves to justify investing in large physical plants, for example, the multi-billion dollar infrastructures common to the Athabasca Oil Sands. Conventional processes use heat, usually hot water, as part of the release process. The use of cold water has important advantages in terms of initial cost, ongoing costs, ease of use, set-up time and planning, maintenance, and environmental impact.

Once the oil is released, separations processes may be used as appropriate to sort-out the oil, water, and sand. Certain separations processes that are particularly effective are set forth herein.

### BRIEF DESCRIPTION OF THE FIGURES

FIG. 1 is a cross-sectional view of a release member for releasing oil from an oil sand;

FIG. 2 depicts a mixing member in fluid communication with, and downstream of, the release member of FIG. 1;

FIG. 3A depicts a top schematic view of a system having the embodiments of FIGS. 1 and 2;

FIG. 3B is an enlarged cross-sectional view of the intake nozzle area of the release member of FIG. 1;

FIG. 4 is a schematic of a plant for recovering oil from oil sands;

FIG. 5A is a top plan view of a scrubber for a solids-separations process;

FIG. 5B is an elevated side view of the scrubber of FIG. 5A; and

FIG. 6 depicts an alternative separations tank for separating sand, water, and oil.

### DETAILED DESCRIPTION OF PREFERRED EMBODIMENTS

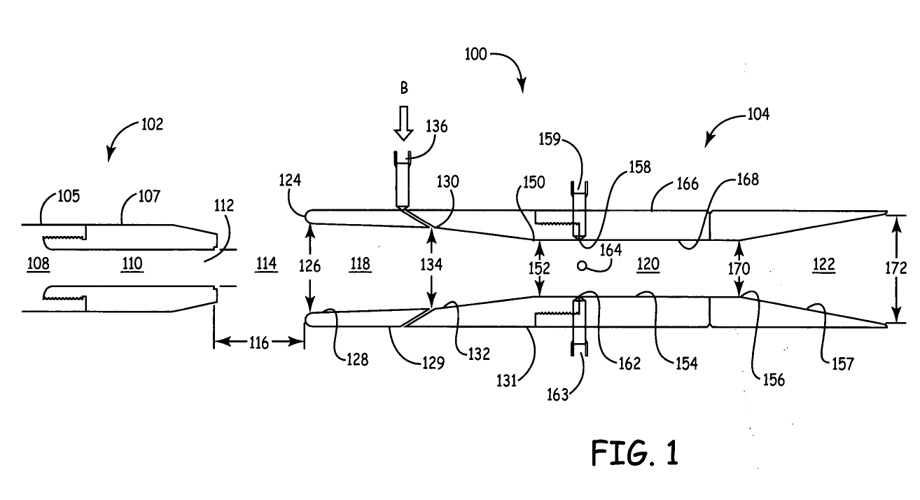

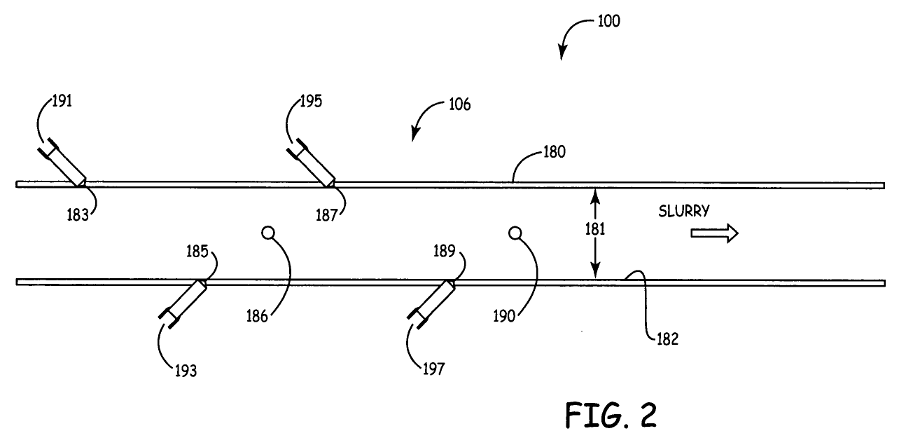

Referring to FIGS. 1-3, system 100 has a supply member 102, a release member 104 and a mixing member 106. Supply member 102 has supply tube 105 and nozzle member 107. Supply tube 105 has bore 108. Nozzle member 107 has bore 110 and supply nozzle 112 that is defined by the inner diameter of nozzle 112 whereby water flows across gap 114. Gap 114 has a length 116. Release member 104 has inlet area 118, constriction area 120 and diffuser area 122. Inlet area 118 has intake nozzle 124 defined by inner diameter 126, a tapered bore 128 and, in the embodiment depicted, gas inlet 130 at gas inlet location 132 definable by diameter 134 as depicted. Release member 104 has hood portion 129 upstream of inlet 130 constriction premixer portion 131. Injector 136 communicates with inlet 130, which extends all around the periphery of the pipe that defines inlet area 118. Constriction area 120 has point of constriction 150 that has diameter 152 and a length 154 from point 150 to transition point 156 that marks the start of diffuser area 122. Diffuser area 122 has tapered bore 157. Four inlets (159, 162, 164 depicted) are located in constriction area 120 and, as depicted, are located at 0, 90 (not shown), 180 and 270 degrees around tube 166 that contains constriction area 122. Four injectors spaced 90 degrees apart (with 159, 161, 163 being depicted) supply gas to four inlets (with 158, 160, 162 being depicted). In the depicted embodiment, the injectors are perpendicular to bore 168 of tube 166. Diffuser area 122 has transition point 156 that marks a transition to tapered bore 157 from diameter 170 to downstream diameter 172. Mixing member 106 is in downstream fluid communication with release member 104, and has tube 180 with diameter 181 and bore 182, which is served by two sets of four inlets 183-190 spaced 90 degrees apart at positions 0, 90, 180, and 270 degrees, each served by an injector that supplies fluids to the same, with injectors 191-193 and 195-197 being depicted. Arrows labeled as slurry indicate the direction of slurry flow.

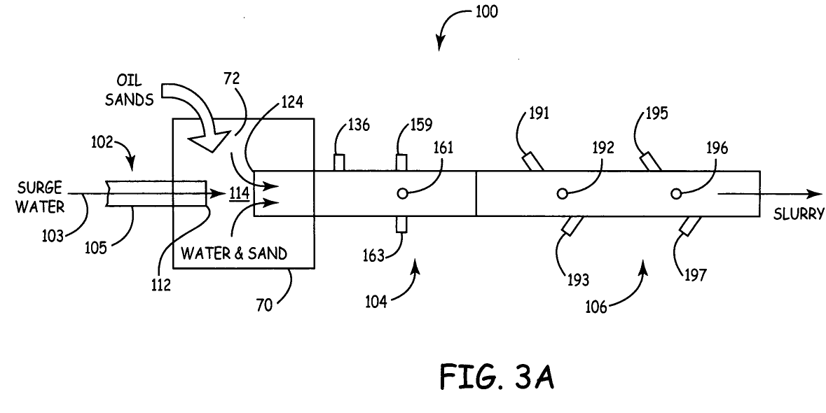

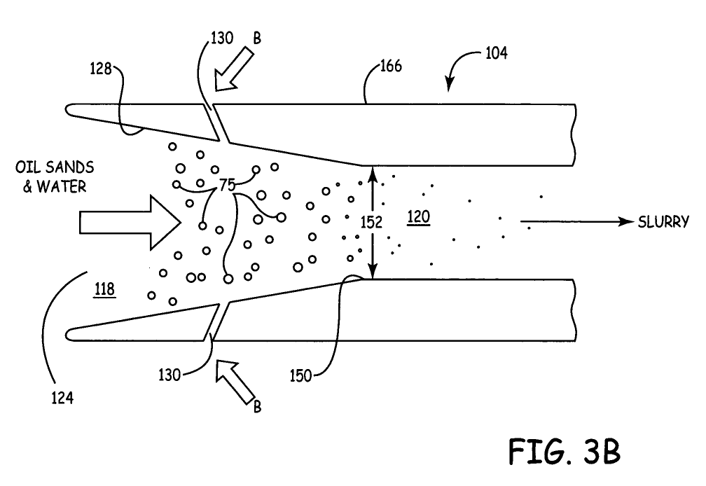

In use, referring to FIGS. 3A and 3B, screened oil sands are moved into container 70 through container opening 72. Source water 103 enters container 72. The source water and oil sands are added to form a slurry that keeps container 72 full enough to cover intake nozzle 124, with the result that ambient air is not pulled into intake nozzle 124, a process referred to herein as feeding, or providing, a slurry free of ambient air. Source water 103 energetically exits supply nozzle 112 and crosses gap 114 into intake nozzle 124, pulling the oil sands into inlet area 118. If the reactor shows a tendency to plug, or becomes blocked, gas, indicated by arrow B, may be forced, or allowed, through inlet 130 into the slurry at or near inlet area 118. Additional gas or a liquid, may be introduced through inlets such as the four inlets described, with inlets 158, 162, 164 being depicted. Further gas or liquid fluids may be introduced downstream, as at the two sets of four inlets 183-190. Release member 104 releases the oil from the oil sand, with mixing member 106 being optional, directly attached to member 104, or alternatively placed farther downstream. The slurry is directed to stations for separation of the oil, water, and solids.

Inlet 130 may extend all around the circumference of the tube so that air or other gas may be introduced at the periphery of the tube. Such circumferential entry may be accomplished with a flange (not shown) that holds the pipe members together, with the flange having a passage connected to an injector or exposed to ambient air. Alternatively, gas could be injected at one or a plurality of points around the circumference of the tube, e.g, with separate injectors. Inlet 130 is not used in some embodiments, or used only in response to complete or partial blockage of the reactor.

Without being bound to a particular theory of operation, release of oil from the solids portion of the oil sand may be accomplished using cold water by flashing air dissolved in the source water into air bubbles that are rapidly burst by high pressure in the reactor tube. Flashing refers to a rapid change in pressure that causes dissolved gas to come out of solution and form bubbles in the reactor. Air bubbles are created downstream of the tube's opening but upstream of a compression region to quickly achieve a desired amount of compression. Bubbles 75 are explosively compressed in constriction 150 to thereby release oil from the oil sands with high efficiency. Since oil sands vary in their quality and composition, it may be helpful to tune the device until the desired degree of release is achieved. One straightforward approach to such tuning is to observe the efficiency of the separations process, e.g., achieving a release of a desired percentage of the total oil in the oil sand, and adjust the parameters that control the explosive compression. Accordingly, nozzle sizes, tube bores, and flow rates can be adjusted as needed to determine which combinations are most effective. This control may generally be achieved by adjusting flow rates, and the size of the constriction area bore relative to the intake nozzle and the supply nozzle, which affects the pressure of the slurry and bubble creation. As is evident, source water is fed through the reactor to achieve the desired effect since the source water has dissolved gases. Moreover, the generation of bubbles from the source water gases advantageously achieves surprisingly effective oil separation because the flashing process forms bubbles throughout the slurry and finely sized bubbles form at the sand-fluid interface where they are most effective to explosively separate oil from the sand. The process, accordingly, is not merely entraining air into a slurry.

In general, the slurry enters a reaction tube as source water passes from a first pressure regime to a relatively lower pressure regime that effectively flashes dissolved gas from the source water, and the slurry moves along a flow path that is compressed by forcing the slurry through an area with a reduced cross sectional area relative to the flow path. Typically, the tube will have a nominal inner diameter and will have a length with a reduced diameter that defines a constricted area or compression region. The compression region is followed by a diffusion region wherein the tube diameter increases to match the inner diameter of the downstream piping, as in a mixing member. In some embodiments, a nozzle intakes the slurry and is tapered or otherwise transitioned to a flow path having a cross-sectional area. In other embodiments, the intake nozzle transitions directly to the constricted region, in which case the amount of reduction is measured as the percentage decrease in cross-sectional area of the maximum inner diameter of the nozzle. Thus a reactor tube may have an entry bore that tapers continuously to a reduced bore in the constriction area or, alternatively, the constriction area can be placed farther downstream of the tube. In some embodiments, the intake nozzle cross-sectional area tapers continuously to the constriction area without an intervening segment. Or, for example, a nozzle may taper to a first diameter bore that is continuous for a length and then the bore may transition to a constricted-diameter bore.

In general, the tubing inner diameter, supply nozzle diameter, and intake nozzle diameter are sized to achieve the desired flow, usually at least 50 gallons per minute (gpm) for commercial application. A tubular reactor can be made with processing rates as needed, e.g., about 50 to about 1000 gpm, e.g, about 250 to about 600 gpm. The supply nozzle diameter will generally be in the range of about 0.5 to about 4 inches for commercial flow rates. The intake nozzle diameter will be larger than the supply nozzle diameter and will generally be in the range of about 1 to about 6 inches. The gap is accordingly set to accommodate entry of oil sands, typically about 1-5 inches. The gap length may be sized to be proportionate to the intake nozzle diameter, e.g. the gap length equals to intake nozzle diameter, or in a range of about 60% to about 150% of the intake nozzle diameter. The gap and intake nozzle are positioned in a container such that the gap and intake nozzle are below the surface of the slurry, so as to avoid intake of ambient gas into the intake nozzle to thereby provide a slurry free of ambient gas. For each of these ranges, artisans will immediately appreciate that all the ranges and values within the explicitly stated ranges are contemplated.

A constricted region with a reduction of between about 10% to about 90% in cross-sectional area is generally useful; artisans will immediately appreciate that all the ranges and values within the explicitly stated ranges are contemplated, e.g., from about 50% to about 80%, or at least 10%. For instance, an inlet cross-sectional area of about 80 cm² could be reduced 10% to a cross-sectional area of about 72 cm² or 20% to about 64 cm². In preferred embodiments, the cross-sectional area is continuously changed with a tapered bore. The changes may be made, for instance, continuously, stepwise, or abruptly. The constriction diameter may sized proportionate to the supply nozzle diameter, e.g., the same, or with the constriction diameter being about 80% to about 200% of the supply nozzle diameter. The inlet in the release member may be placed at a distance relative to the intake nozzle to flash dissolved gas from the source water at the member, e.g., at a position wherein the inner diameter of the release member is between about 50% and about 95% of the intake nozzle diameter, with such placement also allowing for compression of the flashed gas (bubbles or microbubbles) soon after it is introduced, and a change in bubble volume that is rapid. Pressure at the constriction point will depend on specific operating parameters, e.g., a pressure in the range of about 60 to about 300 psig, e.g., about 80 to about 200 psig. The length of the constriction area allows for a residence time to provoke complete collapse of the flashed gas, e.g., a length generally between about 2 to about 10 times the diameter of the supply nozzle. For each of these ranges, artisans will immediately appreciate that all the ranges and values within the explicitly stated ranges are contemplated.

The slurry in the release member may be free of ambient gas, as already described. Further, such slurry may additionally, or alternatively, be free of organic solvent additives, e.g., diesel or kerosene, meaning that no organic solvents, besides those that might be natively present in the oil sands, are added. Similarly, the slurry may also be free of surfactant additives, meaning that no surfactants are added to the slurry or source water, bearing in mind that some oil sands processes use surfactants at various stages of the process. Surfactants include, for example nonionic and ionic surfactants (anionic, cationic, zwitterionic), and the processes may be free of one or more of the same. The release member can be effectively used to release oil without such additives, which can lead to significant environmental advantages and costs savings. Such materials may optionally be added downstream of the process, but some embodiments with at the release member or across the entire oil separations process are altogether free of added organic solvents and/or added solvents and/or added gases.

A mixing member may be used downstream of the release member. The diameter of the mixing member may be chosen to be proportionate to the diameter of the constriction point, and will generally be larger. For commercial applications, the mixing member diameter may be, e.g., 110% to 400% of the constriction point diameter; artisans will immediately appreciate that all the ranges and values within the explicitly stated ranges are contemplated. FIGS. 1-3 show various inlets for introducing additional gas and/or liquid. In general, additional materials may be introduced into the slurry. For example, hydrocarbons may be injected that are miscible with the oil to change the overall density of the oil. Decreasing the oil density can enhance separation of the oil from other slurry components since lighter oil will gravity-separate more rapidly from water. Examples of hydrocarbons are kerosene and diesel. And, for instance, it may be helpful to inject various chemicals as buoyancy aids; these may be adding by taking into account hydrocarbon densities and downstream solids-separations choices. Solids-separations refers to removing solids from the slurry and isolating oil for further processing. Once the oil is released from the oil sands, such processes may be used as needed. Air or other gas may be also added, e.g., to adjust density.

Tube reactor materials, e.g., for the release member and/or mixing member, may optionally be selected to resonantly vibrate in response to the compression of the bubbles. The resonance is theorized to enhance release, perhaps by forcing bubbles to oscillate in size or shape due to the vibration or to localized heating effects. The selection of resonant materials can be made according to tube size, flow rates, slurry densities, and other operational parameters. Examples of materials for the tube include, for example, various metals and alloys, e.g., stainless steels.

Cold water is a term referring, in general, to liquid water of less than about 130° F., and is in contrast to hot water, which is traditionally used for oil sands processing. The reactor can accommodate source water that is hotter or colder; in general, heat does not have to be added to the water so long as the ambient temperature does not freeze the water. Accordingly, an embodiment is a reactor using ambient temperature liquid water. Another embodiment uses unheated water, meaning water that has no heat added to it. Other embodiments use a source water temperature in the range of about 25°-200° F., e.g., about 60 to about 70° F.; artisans will immediately appreciate that all the ranges and values within the explicitly stated ranges are contemplated, e.g., liquid water of less than 150, 140, 130, 120, 110, 105, 100, 90, 80, 70, 60, 50, 40, 30° F. Note that seawater may be used that has a freezing point lower than fresh water. Moreover, reference to temperatures refers to bulk temperatures.

The addition of heat at any stage of the process involves significant cost. Since the oil may be released from the oil sand without hot source water, it is possible to have a process from mining to final oil separations that is free of hot water, with the term also meaning processes free of hot slurries of oil sands and any mixture that includes water. Accordingly, the process may be controlled to maintain a water and/or slurry temperature is a desired range, e.g., freezing point to about 200° F.; artisans will immediately appreciate that all the ranges and values within the explicitly stated ranges are contemplated, e.g., liquid water of less than 150, 140, 130, 120, 110, 105, 100, 90, 80, 70, 60, 50, 40, 30° F., for example, from 25° F. to 105° F. And all or part of any of these processes may be conducted to be free of external heat input, meaning that no heat is added to the reactor from outside sources even though friction, fluid compression, or other internal processes may spontaneously generate some internal heat. The process may be run at ambient temperature, meaning the temperature of the natural surroundings, and may further be free of external heat input.

Moreover, release of oil may be achieved without pH adjustments and/or steps of adding caustic soda; thus the process may be free of ph-adjustment steps, free of the addition of NaOH, and free of the addition of hot caustic solutions. A pH-adjustment step is a term familiar to those practicing these arts and refers to adding reagents as part of a conventional process for release of oil from an oil sand, typically in the form of a solution of hot NaOH.

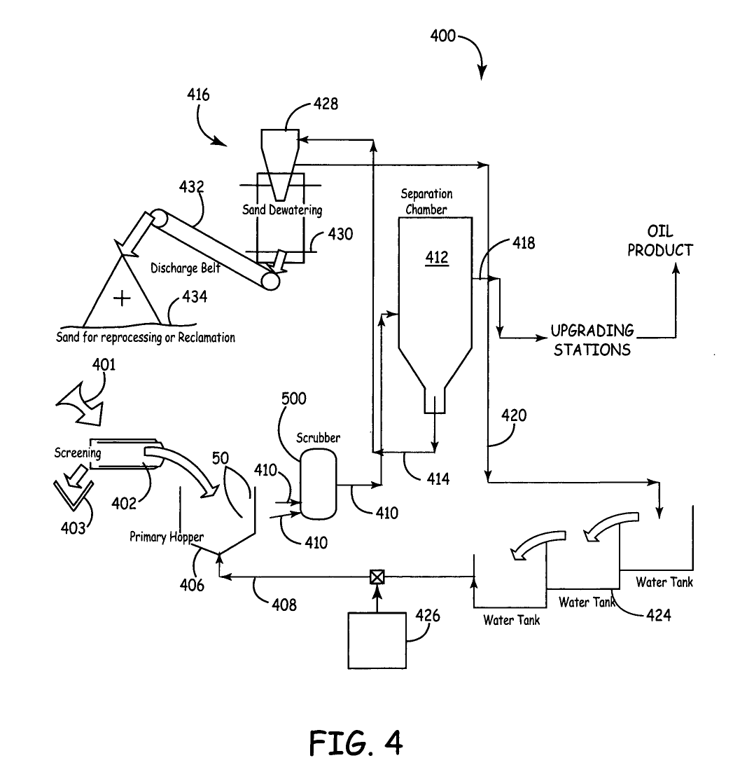

FIG. 4 shows plant 400 to implement an oil separations processes, and is described as a specific embodiment; variations of the same may be implemented as appropriate to facilitate production. Mined oil sands 401 are loaded by track hoe into a raw feed input screener 402, e.g., a Finlay 790 trommel. Sprayers to wet the sand are used as needed for dust or wetting. Screener 402 passes large diameter materials 405 to crusher 403 that crushes the materials for eventual re-presentation to the screener. Screener 402 discharges small diameter materials to a boiling box (not shown), which is a term used to refer to a device mounted onto a screener or conveyor, shaped like a box with no back to change direction of solids flow and to make a preliminary slurry; it does not use hot water. The boiling box adds motive water to the screened oil sand to conveniently move it as a preliminary slurry 404 into the separation reactor(s) 406 that are positioned directly under the boiling box. Water source 408 provides water to reactor 50 (shown schematically without detail in FIG. 4) and discharges processed slurry 410 having oil released from the oil sands into convergent scrubber 500 (described in detail below). In this embodiment, two reactors 50 are used to cooperate with convergent scrubber 500; other embodiments alternatively use more or fewer reactors 50, e.g., with convergent scrubber 500 and/or separations tank 600. Slurry 410 is pumped from convergent scrubber 500 to separations chamber 412 wherein gravity separations separate the oil sands solids from the oil. Solids and water 414 are passed to a dewatering process 416. Oil 418 is passed through a skimmer to remove excess water 420 and sent to an oil finishing process 422 for treatment as needed for subsequent processing, such as pipeline transfer or end-product storage. Excess water 420 is passed to tank or tanks 424 for re-use. Additional source water may be provided as at 426.

Dewatering process 416 involves pumping flow 414 to a wet cyclone 428 to spin out the water. The water is recovered in the storage tanks and reused (not shown). The sand is fed onto a vibrating polyurethane deck 430 where it is shaken vigorously to remove any residual water content to circa 10% by weight. The semi-dry sand is discharged onto a stockpile belt 432, which discharges onto a impermeable base 434 as a stockpile. Conventional upgrading or finishing processes may be used to treat oil 418, e.g., by removal of superfines, filtering, surface tension adjustment, or viscosity treatment.

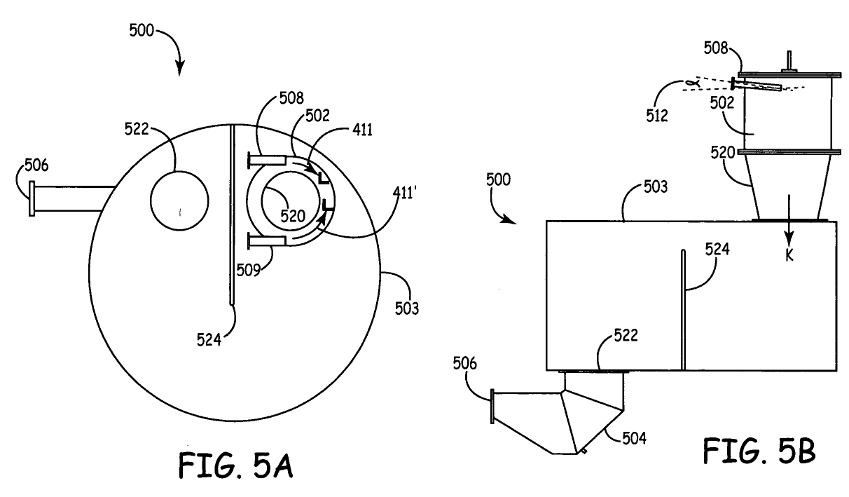

Convergent scrubber 500 depicted in FIGS. 5A, 5B advantageously removes energy from slurry 410 as it comes from reactor(s) 50 to ease solids separations processes. Slurry exits the reactor at a high velocity and high pressure. The convergent scrubber uses two flows against each other to decrease the energy and pressure by opposing the flows to each other, which also increases separation attrition. Advantages include minimizing additional energy inputs and reduction of heights of a separations tank. Specifically, matched flows, e.g., from matched pairs of primary reactors 50, discharge by pipe into an opposed tangential cyclone. The upper portion of the cyclone may be cylindrical, a broad term meaning that the inner walls bend continuously and symmetrically so that the flows impact each other when discharged adjacent to the inner walls with similar force. The two flows converge in the cyclone chamber, where each flow strips against each other. Referring to FIGS. 5A and 5B, scrubber 500 has a cylindrical upper portion 502, tank portion 503, and pipe 504 with discharge 506 tangential to downward flow as indicated at arrow K. Input pipes 508, 509 introduce slurry 410 into upper portion 502 that redirects slurry 410 to two flows 411, 411′ that oppose each other as indicated by arrows L. The outlets are placed at the inner periphery of the cylindrical member so that the curvature of the member redirects the flows against each other. A gravel pump (not shown) redirects slurry 410 to separation chamber 412. Pipes 508, 509 are oriented at a downwards angle alpha as at 512, e.g., between about 2 to about 30 degrees below horizontal, i.e., so that the flow goes downwards; artisans will immediately appreciate that all the ranges and values within the explicitly stated ranges are contemplated, e.g., about 3 to about 10 or about 4 to about 15 degrees. As is evident, a variety of geometries are available for opposing flows and the flows can be matched or deployed in some other proportion to each other to achieve a reduction in energy. Chute 520 provides for flow out of upper portion 502 to tank 503. Chute 522 directs flow out of tank 503. Divider 524 contributes to directing flows for better mixing in tank 503.

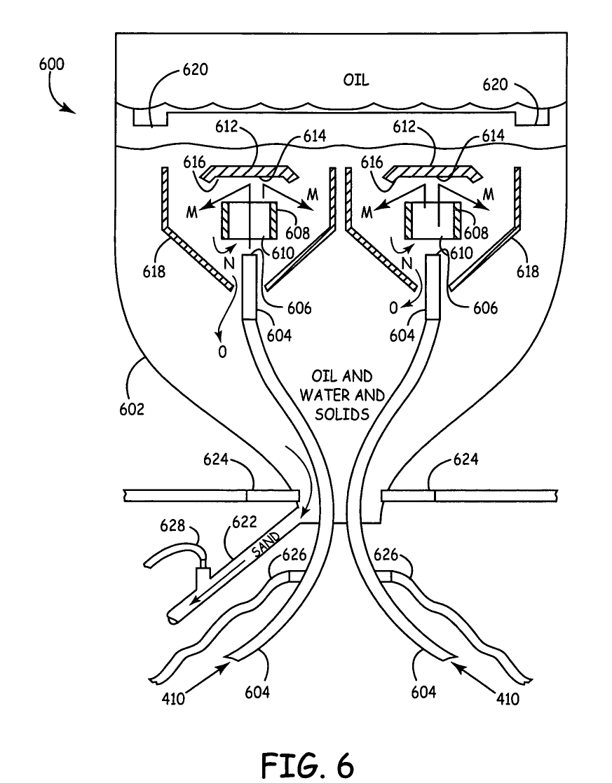

The redirection of the flows against each other uses the kinetic energy of the flows to produce a mixture with a much lower kinetic energy. Opposing the flows substantially reduces the average velocity of the flows, e.g., by about 20% to about 100%; artisans will immediately appreciate that all the ranges and values within the explicitly stated ranges are contemplated. With the kinetic energy dissipated, compact separations may proceed. An alternative is to send the flows up a separations tank wherein gravity acts against the flows to reduce their energy, or a strike plate as in FIG. 6 may also be used.

In some embodiments, the cylindrical member has a parabolic shape, with the outlets oriented towards a side of the parabola for opposition and impact with each other at approximately the inflection point of the parabola. In other embodiments, the outlets are not placed peripherally to a cylinder but are merely directed at each other. In some embodiments, these directly opposing flows are made underneath the top of the mixture formed by the flow; this arrangement can be accomplished, for instance, by discharging the flows from opposite sides of a cylindrical tank, with the fluid level set above the height of the outlets. Similarly, the fluid levels for the embodiment of FIG. 5 may be set above or below the height of the outlets.

Referring to FIG. 4, the slurry enters the top of separation chamber 412 to allow solids to free fall therein. Oil or oil-containing mixtures travel back up to the surface of the contained water and then over a weir by water density stratification. The separated solids fall downwards with the majority of the waters into a sluice duct which is fed into dewatering process 416. A water oil surge tank receives oil 418. Separation chamber 412 may be equipped with additional inlets as appropriate, including water, air, or chemical inlets. Water may be added as needed to keep the slurry level at an appropriate height for the weir or to direct solids out of the chamber. The oil/water from the tar surge tank may be recovered using skimmer technology to minimize water brought into the upgrading system. This water can be recovered back to water storage tanks for reuse. In this embodiment, the separations tank is a conical bottomed unit stood on support legs. More generally, and suitable geometry separations tank may be used, and a sand discharge arrangement is present underneath the separation vessel. The top of the tank has a weir for light fraction fluids to float over into a subsequent catchment hopper for dispatch, upgrading or pelletizing. A device for promoting settlement and diverting the separated products in the correct directions is in the vessel. Flow received from a scrubber is dispersed the flow over a sufficient area to reduce the surface turbulence. The heavier products sink and the light fraction fluids migrate towards the outer weir for recovery. Preferably, the surface area of the unit will be about 1600:1 and the lineal relationship to the surface area will be about four times the surface area in meters. The sand discharge apparatus pumps the separated sands into a sand dewatering device that recovers the waters from the processing of the sands for reuse.

FIG. 6 depicts separations tank 600 as an alternative to scrubber 500 and separations chamber 412. Slurry 410 from one or more reactors 50 enters tank 602 via conduits 604 and passes through nozzles 606 into pipes 608 that have relatively larger openings 610 than openings of nozzles 606. The slurry strikes strike plates 612 and is redirected as in arrows M. Strikeplates 612 may have a bow 614 and a lip 616 as depicted to enhance redirection. A secondary draw is created to pull flow as at arrows N. Solids fall by gravity as at arrow O, with V-bottomed chambers 618 containing flows M and directing solids downwards. Oil rises above the watery slurry to weirs 620 that route oil out of the chamber. One or more conduits allow sand and water to exit. Additional water or chemicals may be added at 624, 626, and/or 628. The choice of separations techniques will depend, in part, on the composition of the oil sands and choice of flow rates or other operating parameters. Advantages include minimizing additional energy inputs and reduction of heights of a separations tank.

### FURTHER DESCRIPTION OF PREFERRED EMBODIMENTS

Accordingly, certain embodiments are an oil sands processing system comprising a release tube, a water supply nozzle and an intake nozzle forming an inlet of the tube, with the nozzles configured to pass water from the supply nozzle to the intake nozzle across a gap positioned to receive oil sand to form a slurry free of ambient air for passage along a flow path, with the intake nozzle diameter being larger than the supply nozzle diameter and the tube further comprising a constriction comprising a diameter that is less than the intake nozzle diameter and greater than the supply nozzle diameter. Two such systems can be run in parallel, with the gaps in the same or different containers, or in the same container with a partition between them. The two systems may generate identical flows or similar flows that are then routed to impact against each other. Sprayers may be used to wet the oil sand prior to entry into a container. In such systems, the intake nozzle may taper from its initial diameter until it is the same as the diameter of the constriction point. The system may have a container with an opening positioned for receiving oil sands, with the nozzles and the gap being inside the container. A fluid level in the container may be kept, for instance, above the intake nozzle, or approximately on level with the same. The water at the supply nozzle may be provided as a liquid with a bulk temperature of less than about, e.g., 80° F. or less than about 100° F. or other temperatures (e.g., ambient) as described herein. The supply nozzle may be sized to achieve a desired flow as described, and/or with a diameter of between about 1 inches and about 3 inches, although other diameters are certainly suitable in certain flow configurations. One option for sizing the constriction is to set the diameter being between about 100% to about 200% of the intake nozzle diameter, e.g., at about 120% to abut 150%, with the intake nozzle diameter optionally being in the 1-3 inch range. Such a system can use any of the scrubbers and/or separations herein, or other devices to further process the slurry with the released oil. The system may be operated with the efficiencies indicated herein. In operation, bubbles may be introduced to the reactor that are forced through the constriction to undergo increased pressurization to release the oil, e.g., at 80-300 or more psig.

Some embodiments are directed to a convergent scrubber. One convergent scrubber embodiment is a scrubber for opposing slurry flows comprising a first pipe with a first outlet and a second pipe with a second outlet, with the first outlet and the second outlet each being tangential to an inner periphery of a cylindrical portion of a vessel to oppose flows from the outlets against each other. The pipes may enter into, and discharge into, the vessel at an angle of between about 2 degrees and about 10 degrees below horizontal. The vessel can be shaped as a cyclone, for instance, or have a cylindrical shape at the discharge points that redirects flow. Some methods, accordingly, relate to discharging a first slurry flow through a first pipe and a first outlet and discharging a second slurry flow through a second pipe and a second outlet, with the first outlet and the second outlet each being tangential to an inner periphery of a cylindrical portion of a vessel that redirects the flows to collide with each other to thereby reduce kinetic energy of the flows. The slurry flows may be from matched release reactors or from one such reactor or a combination of reactors, e.g., by use of appropriate manifolding, to create matched flows. Matched flows have similar force, which is proportional to the density of the flows, their velocities when impacting each other, and the deceleration of the same.

Various embodiments have been described herein, as well as certain features. In general, the features may be mixed-and-matched with each other provided that the overall system is effective to process oil sands to make oil separated from the oil sands.

1. An oil sands processing system comprising a release tube, a water supply nozzle and an intake nozzle forming an inlet of the tube, with the nozzles configured to pass water from the supply nozzle to the intake nozzle across a gap positioned to receive oil sand to form a slurry for passage along a flow path, with the intake nozzle diameter being larger than the supply nozzle diameter and the tube further comprising a constriction comprising a diameter that is less than the intake nozzle diameter and greater than the supply nozzle diameter.

2. The system of claim 1 wherein the intake nozzle diameter tapers down to the constriction diameter.

3. The system of claim 1 further comprising a container with an opening positioned for receiving oil sands, with the nozzles and the gap being inside the container.

4. The system of claim 1 wherein the tube further comprises a gas inlet upstream of the constriction.

5. The system of claim 1 further comprising a slurry in the tube free of ambient air that is an slurry that comprises a mixture of water and oil sands.

6. The system of claim 5 wherein the water at the supply nozzle is liquid with a bulk temperature of less than about 100° F.

7. The system of claim 5 wherein the water at the supply nozzle is liquid with at ambient temperature.

8. The system of claim 1 wherein the supply nozzle has a diameter of between about 1 inches and about 3 inches.

9. The system of claim 1, with the constriction diameter being between about 100% to about 200% of the intake nozzle diameter.

10. The system of claim 1 further comprising a second release tube, a second water supply nozzle and a second intake nozzle forming an inlet of the second tube, with the second supply nozzle and second intake nozzle configured to pass water from the second supply nozzle to the intake nozzle across a second gap positioned to receive oil sand to form a slurry for passage along a second flow path, with the second intake nozzle diameter being larger than the second supply nozzle diameter and the second tube further comprising a second constriction comprising a second diameter that is less than the second intake nozzle diameter and greater than the second supply nozzle diameter.

11. The system of claim 1 further comprising a convergent scrubber comprising a first pipe with a first outlet and a second pipe with a second outlet, with the first outlet and the second outlet each being tangential to an inner periphery of a cylindrical portion of a vessel to oppose flows from the outlets against each other, with at least the first pipe being fluidly connected to the release tube.

12. A method of processing an oil sand comprising:
passing a slurry that comprises source water and the oil sand and is free of ambient gas into a reactor to flash gas dissolved in the water into bubbles that are explosively compressed in the reactor to separate oil from the oil sand, with the slurry at a bulk temperature of less than about 100° F.

13. The method of claim 12 wherein the water is supplied at ambient temperature and the oil is released from the solids without external heat input.

14. The method of claim 13 wherein the slurry is free of organic solvent additives and is free of surfactant additives.

15. The method of claim 12 wherein the reactor comprises a tube, a water supply nozzle and an intake nozzle forming an inlet of the tube, and supply water passing from the supply nozzle to the intake nozzle across a gap that receives oil sand to form the slurry free of ambient gas that flows along a flow path, with the intake nozzle diameter being larger than the supply nozzle and the tube further comprising a constriction comprising a diameter smaller than the intake nozzle diameter and from about 100% to about 200% of the intake nozzle diameter.

16. The method of claim 12 wherein the reactor comprises a tube with a gas inlet at or near the inlet of the tube, and further comprising introducing a gas or fluid through the gas inlet to unblock the inlet of the tube.

17. The method of claim 16 wherein flow from the tube is opposed to a second flow from a second reactor tube to reduce kinetic energy of the slurry.

18. The method of claim 12 wherein the oil sand is an asphaltic bitumen.

19. A convergent scrubber for opposing slurry flows comprising a first pipe with a first outlet and a second pipe with a second outlet, with the first outlet and the second outlet each being tangential to an inner periphery of a cylindrical portion of a vessel to oppose flows from the outlets against each other, with the vessel further comprising a gravity-feed outlet.

20. The scrubber of claim 19 wherein the first pipe and the second pipe outlets enter the vessel at an angle of between about 2 degrees and about 10 degrees below horizontal.

21. The scrubber of claim 19 wherein the outlets each have a diameter of between about 1 inch and about 8 inches.

22. The scrubber of claim 19 further comprising a gravel pump and a tank positioned to receive a discharge from the gravity-feed outlet and further comprising a second gravity-feed outlet.

23. A method of removing solids from a slurry, the method comprising discharging a first slurry flow through a first pipe and a first outlet and discharging a second slurry flow through a second pipe and a second outlet, with the first outlet and the second outlet each being tangential to an inner periphery of a cylindrical portion of a vessel that redirects the flows to collide with each other to thereby reduce kinetic energy of the flows.
